(19) United States
(12) Patent Application Publication
(10) Pub. No.: US 2009/0033472 A1
(43) Pub. Date: Feb. 5, 2009

(54) MEMORY BOARD DEVICE FOR HOME OR ORGANIZATIONAL USE AND USE THEREOF

(76) Inventor: Majid Fotuhi, Cockeysville, MD (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 12/185,502

(22) Filed: Aug. 4, 2008

Related U.S. Application Data
(60) Provisional application No. 60/935,296, filed on Aug. 3, 2007.

(51) Int. Cl. G08B 1/00

(52) U.S. Cl. 340/309.7

(57) ABSTRACT

The present invention relates to a memory board or device that allows for the input of specific tasks that are to effected by the user such as by typing or writing a message or touching a pictorial touch screen on the face of the device and which sends an audible or visual reminder message to the user advising the user that a task is to be effected and comprises a means for inactivating the reminder after the task has been completed. In preferred embodiments the memory device will be connected to another individual or organization who is contacted after a reminder message has not been deactivated after a prescribed time has lapsed.

### RELATED APPLICATIONS

The present invention relates to and claims priority to U.S. Ser. No. 60/935,296 filed on Aug. 3, 2007 which provisional application is incorporated by reference in its entirety herein.

### FIELD OF INVENTION

The present invention relates to a device for home or organizational use that allows for the input of information regarding specific tasks that are to be effected and for specific reminder regarding the specific task to be visually or audibly detected by the user of the device at the time when the task is to be effected.

### BACKGROUND OF THE INVENTION

More and more people are living into their 70's and 80's. In fact, this is the fastest growing portion of our population. As the current baby boomers reach last decade of their lives, they still prefer to live independently for as long as possible; they hate to move into a nursing home or other such facilities. Any means that would facilitate their ability to live in their own environment for a longer period of time would be of great interest to them, and especially their children.

The main reason for being unable to live independently is memory loss and dementia, not physical limitations. Elderly have a tendency to forget taking their medications, going to their appointments, or paying their bills. Those with early stages of dementia need reminders on a daily basis. Family members not living with them often worry about them and their health. Did they take their medication? Did they go to see the doctor?

### DESCRIPTION AND OBJECTS OF THE INVENTION

The present invention relates to a memory device or memory board referred to herein also as an “mBoard” that is adopted for home or organizational use that allows for the input of specific information regarding a task or tasks that is or are to be effected by the user of the device and which device provides for an audible or visual reminder to be detected by the user at the time or times that the task(s) is (are) to be effected and which further provides for the reminder to be inactivated by the user.

In addition, the present invention provides methods for relaying information to individuals, e.g., daily tasks such as turning off appliances, locking doors, paying bills and the like by use of such mBoard. Preferably the users of the mBoard will comprise individuals with diseases such as Alzheimer's disease or stroke or dementia or environmental factors such as stress that impair the memory of such individuals and in particular their ability to remember specific daily tasks that may be required for living independently.

Preferably, the device is such that it can be attached or integrated into a household appliance such as a refrigerator door or attached to a car dashboard during travel. This device preferably is adopted for use by elderly or .memory impaired individuals. The device will provide for reminders to be input such as by writing or typing or a touch pad which allows for specific messages to be input and for reminders to be visually or audibly displayed. For example, the reminder may advise a user to take a specific medication, to turn on or off a specific appliance, or other task that is to be effected.

Also, the device will have or be connected to some means such as a button or switch that allows for the user to deactivate the reminder after the task has been effected. For example, the device may have a light up button that when touched changes for example from red to green when the reminder is deactivated.

In some embodiments, the “mBoard” will further preferably be connected via the internet or telephone or cable to another individual or organization such as a caregiver, hospital, police, ambulance service or family member and will inform this individual or organization when the user of the device has not deactivated the reminder message after a specific amount of time has lapsed.

Therefore, it is an object of the invention to provide a memory device that provides for:

(i) the input of information regarding a specific task or tasks that is (are) to be effected at a specific time or times;

(ii) a visual or audible reminder to be provided to a user of the device that informs the user that the specific task is to be effected; and

(iii) which device has a button that must be touched on the device to inactivate or pause the audible or visual reminder. In preferred embodiments, this memory device is connected to a telephone or internet connection and is set up to contact another individual or organization if the user of the device fails to inactivate the reminder after a specific time. has lapsed.

This memory device can be of any size that facilitates the display of specific reminders to an individual, e.g., one with a condition that impairs memory. In preferred embodiments the memory device will be about 4-24 inches in size (width and/or length) and more typically about 6-12 inches in size or 6-8 inches in size, such that it may be easily attached on integrated into a household appliance such as a refrigerator door or medicine cabinet. In some embodiments the memory device will the user of a reminder message by a light or a typed or written message or pictorial message that appears on the face of the device when the task is to be effected. In other embodiments the memory device advises the user of a reminder message by an audible reminder such as a beeping or chirping sound or a voice message advising the user that there is a pending reminder to perform the specific task.

Because many of the individuals with memory issues may also have hearing impairment the device may deliver an audible reminder gets progressively louder after a certain time has lapsed if the reminder message is not deactivated at the appointed time.

In other embodiments the memory device may be connected to a light which is turned on after a certain time has lapsed after the reminder message has not been deactivated, e.g., a light is turned on in a room or rooms where the user sleeps.

In preferred embodiments the memory device is connected to a radio or telephone that is turned on or off after a certain time has lapsed after the reminder message has not been deactivated.

In other preferred embodiments the memory device has buttons that light up on the memory board when the message is to be effected or has been completed.

In still other embodiments the memory board will have a green or other color light advising the user that there are no pending reminders and another color light, e.g., a red and/or yellow light informing the user that a reminder message is pending which should be deactivated after the task has been completed. For example, the reminder light may be yellow when the individual signals that the reminder has been received but that the task is not yet completed and the reminder light may be red light when the individual has not yet acknowledged receipt of the reminder.

As mentioned, in preferred embodiments, the memory device is further connected electronically or via a telephone connection to a caregiver, hospital, ambulance service or police department who is contacted a certain time after a reminder concerning a specific task has not been deactivated by the user of the memory device.

As noted, in preferred embodiments this memory device will be attached to or integrated into a household appliance or medicine cabinet or integrated into a refrigerator door. This integrated memory device will typically comprise a reminder button that is a specific color or lights up when an individual indicates that he or she has received a reminder (specific information) associated with said button and which button turns another color or has another button that lights up when an individual indicates that he or she has completed a specific task associated with said reminder button.

In preferred embodiments this memory device is used in the management of care of an individual with a disease or condition that impairs the individual from otherwise remembering to complete routine tasks required for day to day living. For example, the individual may have a condition that impairs memory which is selected from dementia, mild to medium level Alzheimer's disease, stroke, a head injury that impairs memory, atherosclerosis or hardening of the arteries, a congenital neurological condition that impairs memory or a stress related condition.

For example, the memory device may be used to help individuals living in an assisted living center or group home in order to facilitate there completing day to day tasks. As noted, in such context the memory device may deliver a visual or audible reminder informing the individual to complete a task or tasks involved in day yo day living. Examples of such tasks include by way of example turning on or off an appliance, turning the water on or off, locking a door, turning on or off a security system, getting the mail, putting food back in the refrigerator, telephoning a relative or caregiver, feeding an animal, walking a dog, taking a pill, paying a bill and the like. Preferably, in such context f the reminder is not acknowledged by the individual as being completed with a specified time period a caregiver or other individual will notified telephonically or electronically (e.g. message delivered to a PDA device or computer) advising that such individual has not completed a specific task.

### BRIEF DESCRIPTION OF THE DRAWING

FIG. 1 is a schematic of a memory device according to the invention.

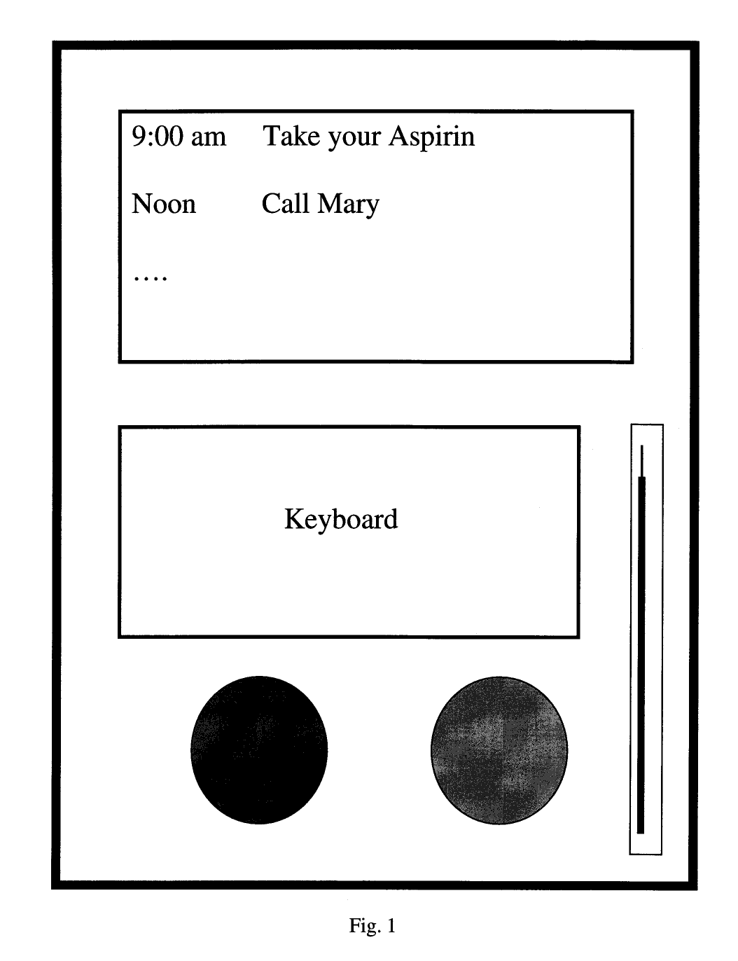

### DESCRIPTION OF THE INVENTION

Therefore present invention relates to a memory device or memory board referred to herein also as an “mBoard” that is adopted for home or organizational use that allows for the input of specific information regarding a task or tasks that is or are to be effected by the user of the device and which device provides for an audible or visual reminder to be detected by the user at the time or times that the task(s) is (are) to be effected and which further provides for the reminder to be inactivated by the user.

In addition, the present invention provides methods for relaying information to individuals, e.g., daily tasks such as turning off appliances, locking doors, paying bills and the like by use of such mBoard. Preferably the users of the mBoard will comprise individuals with diseases such as Alzheimer's disease or stroke or dementia or environmental factors such as stress that impair the memory of such individuals and in particular their ability to remember to complete specific daily tasks that may be required for living independently.

Preferably, the device is such that it can be attached or integrated into a household appliance such as a refrigerator door or attached to a car dashboard during travel. This device preferably is adopted for use by elderly or .memory impaired individuals. The device will provide for reminders to be input such as by writing or typing or a touch pad which allows for specific messages to be input and for reminders to be visually or audibly displayed. For example, the reminder may advise a user to take a specific medication, to turn on or off a specific appliance, or other task that is to be effected.

Also, the device will have or be connected to some means such as a button or switch that allows for the user to deactivate the reminder after the task has been effected. For example, the device may have a light up button that when touched changes for example from red to green when the reminder is deactivated.

In some embodiments, the “mBoard” will further preferably be connected via the internet or telephone or cable to another individual or organization such as a caregiver, hospital, police, ambulance service or family member and will inform this individual or organization when the user of the device has not deactivated the reminder message after a specific amount of time has lapsed.

In general the “mboard” may be described as follows:

What is mBoard?
a device that provides reminders
easy to set up for daily, weekly, monthly, or yearly entries
6×8 inches in size, to be placed on a fridge door (or incorporated into it); or on a table as a frame
the entries can be either typed, or hand-written (on a remote computer)
gives alarms by a beeping sound, voice synthesizer, or red blinking light
user presses a button, e.g., a green button to acknowledge receiving the reminder
can also be programmed such that the person living alone needs to press the green button twice a day (for example between 9-11 am and 7-9 pm), to provide reassurance that no problems exist; pressing the red button would be a signal for help
an alternative use would be for families to get reminders about daily or weekly group activities (as a calendar board for events), for example it would beep an hour before the soccer game to reminder mom to get ready for taking the kids to the game.
   Who can use the mBoard?
elderly living by themselves, wishing to get frequent reminders
busy families wishing to share a common board/calendar on the fridge for schedule of various activities by each person
patients with memory problems, such as those with traumatic brain injury, congenital neurological defects that affect memory, stroke, mild dementia or mild Alzheimer's or stress related conditions that impair memory and in particular that impair the ability of the individual to keep track of routine tasks necessary for unsupervised living.
   How does it work?
basic function similar to that of a PDA organizer
new entries can be either typed (touch screen) or hand-written (stylet), both on the device and also remotely from any computer
user can scroll up and down the side bar on the side to review past, current, or future entries
   Preferred Additional (Optional) Features of the mBoard:
a wireless connection with a PC in the house can be added for providing the ability for monitoring of the device remotely through internet access
may be able to upgrade for daily “message” for family: be kind.

A schematic depicting an exemplary “mBoard” according to the invention is depicted below. It can be seen therefrom that this depicted device allows for the visual display of specific reminders. and has buttons that allow for specific reminders to be deactivated by pushing the correct button after the task has been effected. Also, it can be seen that he exemplary device allows for the input of information regarding the specific tasks by typing or writing a message on the keyboard.

Alternatively, the device may comprise a touch screen containing pictures designating certain tasks such as the taking of medication (e.g., the touchscreen may include pictorial choices such as a pill signifying medication to be taken, a telephone conveying that a call is to be effected, a doctor conveying a doctor visit, a picture of an oven or iron conveying that an appliance should be turned of and the like.

Advantages of mBoard:

mBoard is a simple device that can be placed on a fridge door or as a frame on the table. It is easy to set up by the elderly or their family members to give reminders at specific times, either as a beeping sound, a voice, or a red light. Users then simply press the green button to confirm that they indeed received the reminder. Family members can help to set up the mBoard and make sure that all the entries are updated and current.

This device brings peace of mind and a feeling of safely both to users living by themselves, and more importantly, to their family members who care and are concerned about them.

Having now described the invention and its preferred embodiments the invention is now described in the claims which follow.

What is claimed is:

1. A memory device that provides for:
(i) the input of information regarding a specific task or tasks that is (are) to be effected at a specific time or times;
(ii) a visual or audible reminder to be provided to a user of the device that informs the user that the specific task is to be effected; and
(iii) which device has a button that must be touched on the device to inactivate or pause the audible or visual reminder.

2. The memory device of claim 1 which is connected to a telephone or internet connection and is set up to contact another individual or organization if the user of the device fails to inactivate the reminder after a specific time. has lapsed.

3. The memory device of claim 1 which is about 6-8 inches in size and may be attached on integrated into the door of a household appliance.

4. The memory device of claim 1 which advises the user of a reminder message by a light or a typed or written message or pictorial message that appears on the face of the device when the task is to be effected.

5. The memory device of claim 1 which advises the user of a reminder message by an audible reminder.

6. The memory device of claim 5 wherein the audible reminder is a beeping or chirping sound or a voice message advising the user to perform the specific task.

7. The memory device of claim 6 wherein the audible reminder gets progressively louder after a certain time has lapsed if the reminder message is not deactivated at the appointed time.

8. The memory device of claim 1 which is connected to a light which is turned on after a certain time has lapsed after the reminder message has not been deactivated.

9. The memory device of claim 8 which is connected to a light that is turned on in a room or rooms where the user sleeps.

10. The memory device of claim 1 which is connected to a radio or telephone that is turned on or off after a certain time has lapsed after the reminder message has not been deactivated.

11. The memory device of claim 1 which has buttons that light up on the memory board when the message is to be effected or has been completed.

12. The memory board of claim 11 which contains a green light advising the user that there are no pending reminders and a red and/or yellow light informing the user that a reminder message is pending which should be deactivated after the task has been completed.

13. The memory board of claim 12 wherein the reminder light is yellow when the individual signals that the reminder has been received but that the task is not yet completed and the reminder light is red light when the individual has not yet acknowledged receipt of the reminder.

14. The memory device of claim 2 which is connected electronically or via a telephone connection to a caregiver, hospital, ambulance service or police department who are contacted a certain time after a reminder concerning a specific task has not been deactivated by the user of the memory device.

15. A memory device according to claim 1 which is attached to or integrated into a household appliance or medicine cabinet.

16. The memory device of claim 15 which is integrated into a refrigerator door.

17. The memory device of claim 1 which comprises a reminder button that is a specific color or lights up when an individual indicates that he or she has received a reminder (specific information) associated with said button and turns another color or lights up when an individual indicates that he or she has completed a specific task associated with said reminder button.

18. A method of using a memory device according to claim 1 in the management of care of an individual with a disease or condition that impairs the individual from otherwise remembering to complete routine tasks required for day to day living.

19. The method of claim 18 wherein the individual has a condition that impairs memory which is selected from dementia, mild to medium level Alzheimer's disease, stroke, a head injury that impairs memory, atherosclerosis or hardening of the arteries, a congenital neurological condition that impairs memory or a stress related condition.

20. The method of claim 18 wherein the memory device is used to help individuals living in an assisted living center or group home in order to facilitate there completing day to day tasks.

21. The method of claim 18 wherein the memory device delivers a visual or audible reminder informing the individual to complete a task or tasks selected from turning on or off an appliance, turning the water on or off, locking a door, turning on or off a security system, getting the mail, telephoning a relative or caregiver, feeding an animal, walking a dog, taking a pill, or paying a bill.

22. The method of claim 18 wherein if the reminder is not acknowledged by the individual as being completed with a specified time period a caregiver or other individual is notified telephonically or electronically (e.g. to a PDA device or computer) that such individual has not completed a specific task.
